(19) United States
(12) Patent Application Publication
(10) Pub. No.: US 2020/0062349 A1
(43) Pub. Date: Feb. 27, 2020

(54) UNDERWATER LAUNCHING APPARATUS FOR SMALL UNMANNED AERIAL VEHICLE CAPABLE OF FLOATING ON WATER

(71) Applicant: Dalian University of Technology, Dalian, Liaoning (CN)

(72) Inventors: Ximing SUN, Dalian, Liaoning (CN); Zongyang LV, Dalian, Liaoning (CN); Shuo ZHANG, Dalian, Liaoning (CN); Xinglin YU, Dalian, Liaoning (CN)

(21) Appl. No.: 16/341,411

(22) PCT Filed: Oct. 23, 2017
(86) PCT No.: PCT/CN2017/107293

§ 371 Date: Apr. 11, 2019

(51) Int. Cl. B63B 22/28; B64F 1/06

(52) U.S. Cl. CPC B63B 22/28; B64F 1/06

(57) ABSTRACT

An underwater launching apparatus for a small unmanned aerial vehicle capable of floating on water, having an airbag, inflating module, airbag arm, cylindrical body, upper baffle plate, spring, airbag arm connecting rod, lower baffle plate, upper buckle and lower buckle. This apparatus has compact and reliable structure. Relative to a traditional underwater catapult, the apparatus has smaller body and completes deployment and ejection of the launching apparatus by means of elasticity of the spring. The underwater launching apparatus for the small unmanned aerial vehicle has high stability and diversified applications. After the airbag arm of the catapult is deployed on the water and the inflating module inflates the airbag, developed area is larger and resistance to wind and waves is stronger. In a deployed state, a sensor on the unmanned aerial vehicle can be matched and steadily deployed on the water for investigation.

### TECHNICAL FIELD

The present invention belongs to the technical field of unmanned aerial vehicle catapults, and particularly to an underwater launching apparatus for a small unmanned aerial vehicle capable of floating on water.

### BACKGROUND

At present, unmanned aerial vehicles are applied to more and more occasions. In some scenarios, the unmanned aerial vehicles need to be launched underwater. Because of high underwater resistance, requirements for controllers or structures are relatively high if the unmanned aerial vehicles directly take off from the water. If a special launching apparatus is used to eject the unmanned aerial vehicles from the water, the design of the structures and the controllers of the unmanned aerial vehicles will be simplified. Traditional underwater launching modes include underwater rocket ejection, high-pressure pump ejection, etc., but are complicated in the structures and high in cost, and are wasteful for launching small unmanned aerial vehicles. Therefore, an underwater launching apparatus for small unmanned aerial vehicles having low cost and high reliability and capable of floating on water is needed.

### SUMMARY

The purpose of the present invention is to provide an underwater launching apparatus for a small unmanned aerial vehicle capable of realizing steady floating and deployment of an unmanned aerial vehicle on water and capable of ejecting the unmanned aerial vehicle to air and having low cost and high reliability.

The present invention adopts the following technical solution:

An underwater launching apparatus for a small unmanned aerial vehicle capable of floating on water comprises an airbag 1, an inflating module 2, an airbag arm 3, a cylindrical body 4, an upper baffle plate 5, a spring 6, an airbag arm connecting rod 7, a lower baffle plate 8, an upper buckle 9 and a lower buckle 10.

The underwater launching apparatus for the small unmanned aerial vehicle comprises the cylindrical body 4 and a plurality of regulating mechanisms; the regulating mechanisms are hinged to the bottom of the cylindrical body 4, and are symmetrically arranged using the cylindrical body 4 as a center.

The cylindrical body 4 is a hollow cylinder, and an inner wall of the cylindrical body 4 is provided with buckles, i.e., the upper buckle 9 and the lower buckle 10; the upper buckle 9 and the lower buckle 10 are respectively used for clamping the upper baffle plate 5 and the lower baffle plate 8; the spring 6 is limited between the upper baffle plate 5 and the lower baffle plate 8; and the upper baffle plate 5 and the lower baffle plate 8 can slide along the inner wall of the cylindrical body 4.

Each of the regulating mechanisms comprises the airbag 1, the inflating module 2 and the airbag arm 3; the airbag 1 is connected to the end part of the airbag arm 3 and is regulated and controlled by the inflating module 2; the inflating module 2 is placed in the airbag arm 3; after the regulating mechanism is expanded, the inflating module 2 inflates the airbag 1 and a ring of inflated airbag 1 is formed around the launching apparatus to ensure that the launching apparatus comes up and steadily floats on water.

One end of the airbag arm connecting rod 7 penetrates through the cylindrical body 4 and is hinged to the lower baffle plate 8, and the other end is hinged to the regulating mechanism; when the lower buckle 10 is locked, the airbag arm connecting rod 7 is stowed in an opening of the cylindrical body 4 to control the regulating mechanisms 3 to attach to the outer part of the cylindrical body 4; when the lower buckle 10 is unlocked, the lower baffle plate 8 moves downwards in the cylindrical body 4 and the airbag arm connecting rod 7 is pushed to control to open the regulating mechanisms.

The present invention has the following beneficial effects that:

(1) compact and reliable structure: relative to a traditional underwater catapult, the present invention has smaller body and completes deployment and ejection of the launching apparatus by means of elasticity of the spring; and

(2) high stability and diversified applications: after the airbag arm of the catapult is deployed on the water and the inflating module inflates the airbag, developed area is larger and resistance to wind and waves is stronger; and in a deployed state, a sensor on the unmanned aerial vehicle can be matched and steadily deployed on the water for investigation.

### DESCRIPTION OF DRAWINGS

FIG. 1a is a front view of a launching apparatus structure of the present invention.

FIG. 1b is a local amplified schematic diagram of a launching apparatus of the present invention.

FIG. 1c is a local amplified schematic diagram of a launching apparatus of the present invention.

FIG. 1d is a local amplified schematic diagram of a launching apparatus of the present invention.

FIG. 2 is an amplified diagram of a bottom structure of a launching apparatus of the present invention.

FIG. 3 is a front view of a launching apparatus structure of the present invention.

FIG. 4 is a top view of a launching apparatus structure of the present invention.

FIG. 5 is a schematic diagram of a launching process of the present invention.

In the drawings: 1 airbag; 2 inflating module; 3 airbag arm; 4 cylindrical body; 5 upper baffle plate; 6 spring;

7 airbag arm connecting rod; 8 lower baffle plate; 9 upper buckle; and 10 lower buckle.

### DETAILED DESCRIPTION

Specific embodiments of the present invention are described below in detail in combination with the technical solution and accompanying drawings.

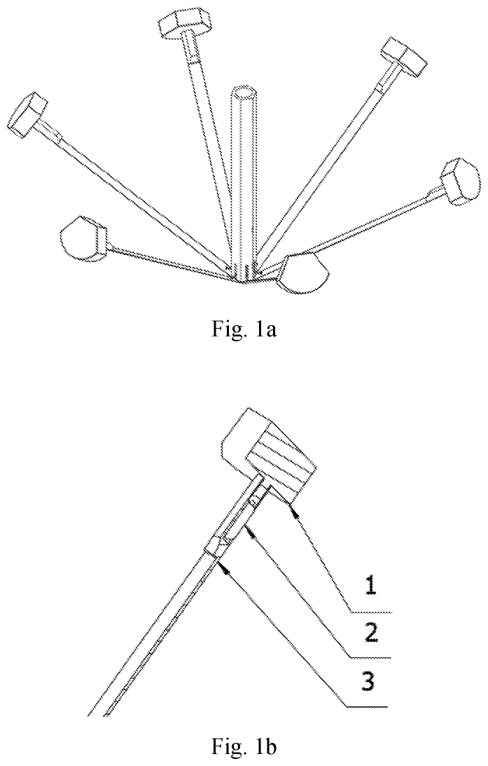

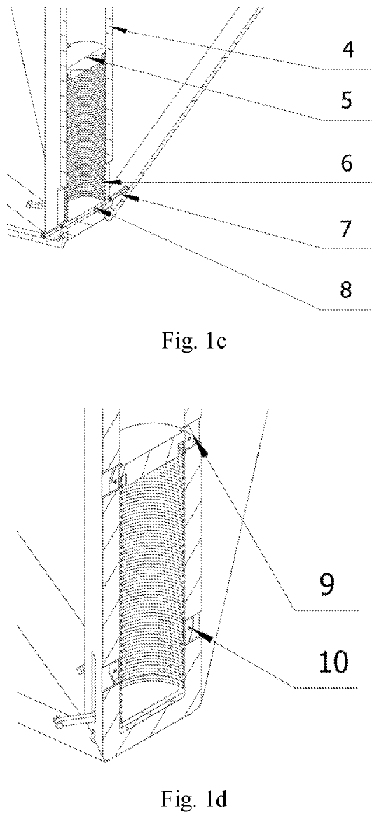

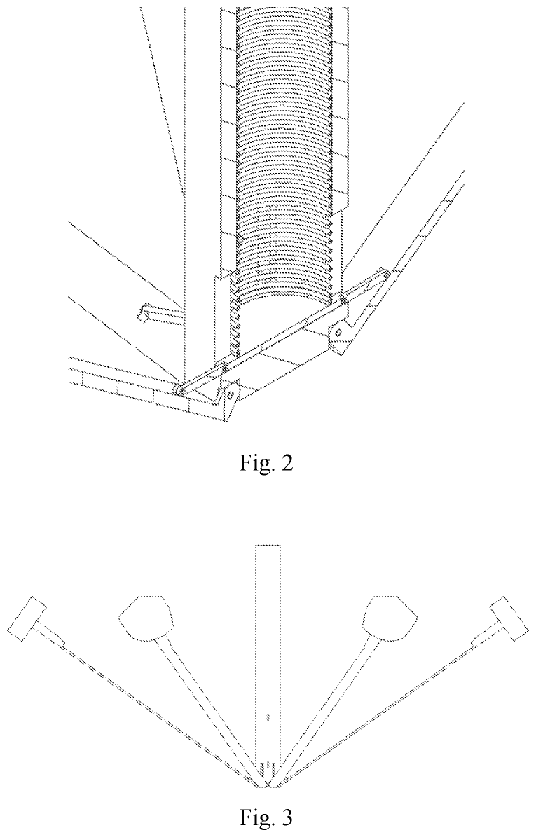

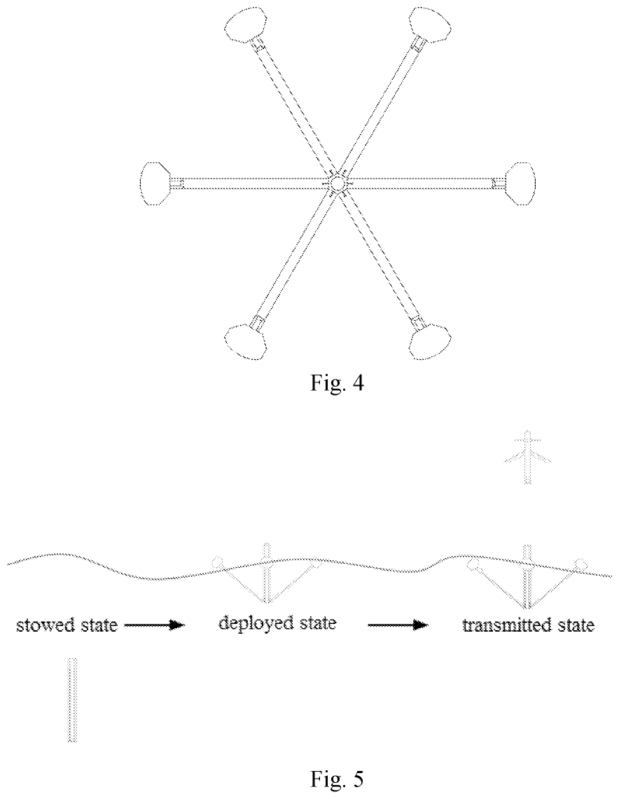

Combined with FIG. 1 to FIG. 5, an underwater launching apparatus for a small unmanned aerial vehicle capable of floating on water comprises an airbag 1, an inflating module 2, an airbag arm 3, a cylindrical body 4, an upper baffle plate 5, a spring 6, an airbag arm connecting rod 7, a lower baffle plate 8, an upper buckle 9 and a lower buckle 10.

The underwater launching apparatus for the small unmanned aerial vehicle comprises the cylindrical body 4 and a plurality of regulating mechanisms; the regulating mechanisms are hinged to the bottom of the cylindrical body 4, and are symmetrically arranged using the cylindrical body 4 as a center.

The cylindrical body 4 is a hollow cylinder, and an inner wall of the cylindrical body 4 is provided with buckles, i.e., the upper buckle 9 and the lower buckle 10; the upper buckle 9 and the lower buckle 10 are respectively used for clamping the upper baffle plate 5 and the lower baffle plate 8; the spring 6 is limited between the upper baffle plate 5 and the lower baffle plate 8; and the upper baffle plate 5 and the lower baffle plate 8 can slide along the inner wall of the cylindrical body 4.

Each of the regulating mechanisms comprises the airbag 1, the inflating module 2 and the airbag arm 3; the airbag 1 is connected to the end part of the airbag arm 3 and is regulated and controlled by the inflating module 2; the inflating module 2 is placed in the airbag arm 3; after the regulating mechanism is expanded, the inflating module 2 inflates the airbag 1 and a ring of inflated airbag 1 is formed around the launching apparatus to ensure that the launching apparatus comes up and steadily floats on water.

One end of the airbag arm connecting rod 7 penetrates through the cylindrical body 4 and is hinged to the lower baffle plate 8, and the other end is hinged to the regulating mechanism; when the lower buckle 10 is locked, the airbag arm connecting rod 7 is stowed in an opening of the cylindrical body 4 to control the regulating mechanisms 3 to attach to the outer part of the cylindrical body 4; when the lower buckle 10 is unlocked, the lower baffle plate 8 moves downwards in the cylindrical body 4 and the airbag arm connecting rod 7 is pushed to control to open the regulating mechanisms.

A launching process of the underwater launching apparatus for the small unmanned aerial vehicle capable of floating on water is divided into the following three states:

(1) Stowed State

In the stowed state, the upper baffle plate 5 and the lower baffle plate 8 are locked by the upper buckle 9 and the lower buckle 10 and the regulating mechanisms are stowed around the cylindrical body 4;

(2) Deployed State

In the deployed state, the lower buckle 10 is released and the lower baffle plate 8 moves downwards under the action of the spring 6; the regulating mechanisms are deployed by the airbag arm connecting rod 7; at this moment, the inflating module 2 inflates the airbag 1; and buoyancy generated by the airbag 1 enables the launching apparatus to come up to the water;

(3) Transmitted State

In the transmitted state, the upper buckle 9 is released and the upper baffle plate 5 moves upwards under the action of the spring 6 to push the unmanned aerial vehicle to eject out of the water.

1. An underwater launching apparatus for small unmanned aerial vehicle capable of floating on water, wherein the underwater launching apparatus for the small unmanned aerial vehicle comprises an airbag, an inflating module, an airbag arm, a cylindrical body, an upper baffle plate, a spring, an airbag arm connecting rod, a lower baffle plate, an upper buckle and a lower buckle;
the underwater launching apparatus for the small unmanned aerial vehicle comprises the cylindrical body and a plurality of regulating mechanisms; the regulating mechanisms are hinged to the bottom of the cylindrical body, and are symmetrically arranged using the cylindrical body as a center;
the cylindrical body is a hollow cylinder, and an inner wall of the cylindrical body is provided with buckles, i.e., the upper buckle and the lower buckle; the upper buckle and the lower buckle are respectively used for clamping the upper baffle plate and the lower baffle plate; the spring is limited between the upper baffle plate and the lower baffle plate; the upper baffle plate and the lower baffle plate can slide along the inner wall of the cylindrical body;
each of the regulating mechanisms comprises the airbag, the inflating module and the airbag arm; the airbag is connected to the end part of the airbag arm and is regulated and controlled by the inflating module; the inflating module is placed in the airbag arm; after the regulating mechanism is expanded, the inflating module inflates the airbag and a ring of inflated airbag is formed around the launching apparatus to ensure that the launching apparatus comes up and steadily floats on water;
one end of the airbag arm connecting rod penetrates through the cylindrical body and is hinged to the lower baffle plate, and the other end is hinged to the regulating mechanism; when the lower buckle is locked, the airbag arm connecting rod is stowed in an opening of the cylindrical body to control the regulating mechanisms to attach to the outer part of the cylindrical body; when the lower buckle is unlocked, the lower baffle plate moves downwards in the cylindrical body and the airbag arm connecting rod is pushed to control to open the regulating mechanisms;
a launching process of the underwater launching apparatus for the small unmanned aerial vehicle capable of floating on water is divided into the following three states:
(1)
in a stowed state, the upper baffle plate and the lower baffle plate are locked by the upper buckle and the lower buckle and the regulating mechanisms are stowed around the cylindrical body;
(2)
in a deployed state, the lower buckle is released and the lower baffle plate moves downwards under the action of the spring; the regulating mechanisms are deployed by the airbag arm connecting rod; at this moment, the inflating module inflates the airbag; and buoyancy generated by the airbag enables the launching apparatus to come up to the water;
(3)
in a transmitted state, the upper buckle is released and the upper baffle plate moves upwards under the action of the spring to push the unmanned aerial vehicle to eject out of the water.
